(19) United States
(12) Patent Application Publication
(10) Pub. No.: US 2005/0027547 A1
(43) Pub. Date: Feb. 3, 2005

(54) Chinese / Pin Yin / english dictionary

(75) Inventors: Yen-Fu Chen, Austin, TX (US); John W. Dunsmoir, Austin, TX (US)

Correspondence Address: Rudolf O. Siegesmund, Suite 2000, 4627 N. Central Expressway, Dallas, TX, 75205-4017, US

(73) Assignee: International Business Machines Corporation, Armonk, NY (US)

(21) Appl. No.: 10/631,070

(22) Filed: Jul. 31, 2003

(51) Int. Cl. G06F 17/60

(52) U.S. Cl. 705/1

(57) ABSTRACT

A method for translating between a Simplified Chinese character, a Traditional Chinese character, a Pin Yin word, and an English word is disclosed. The present invention comprises a Dictionary Program (DP). The DP accepts a character or word in Big 5, GB2312, ASCII, or any Unicode encoding scheme and translates the character or word into Unicode. The DP translates the user input, as required, into the Traditional Chinese character, the Simplified Chinese character, the accented Pin Yin word, and the English word. The user may designate whether the user input is the entire desired word, the beginning of the desired word, or appears anywhere in the desired word. The user may also configure the display size of the Chinese characters.

### FIELD OF THE INVENTION

The present invention is directed to a method for translating between Simplified Chinese characters, Traditional Chinese characters, Pin Yin, and English.

### BACKGROUND OF THE INVENTION

Sino-Tibetan based languages, such as Chinese, are vastly different than Latin based languages such as English. The Chinese language does not contain an alphabet. Instead, the Chinese language comprises more than 60,000 individual characters. Each of the 60,000 characters has a different meaning. Knowledge of about 1,200 characters is sufficient to read a Chinese newspaper. Chinese college graduates know about 3,000 characters.

Chinese also differs from Latin based languages in the concept of a word. In Chinese, strings of characters do not contain spaces and the interpretation of where one word ends and another starts is entirely based on context. Chinese characters are very precise in meaning, pronunciation, and in the way they are written. If a Chinese character has characters added to it in a string, the meaning of the first character is enhanced, but normally it is not changed.

Chinese characters are always pronounced as a single syllable. There are no two-syllable Chinese characters. Each Chinese character has one of five fundamental sounds. These five fundamental sounds give a singing quality to Chinese because some characters are pronounced with high tones, some with low tones, and some with tones that are rising or falling. Tone is fundamental to the language and Chinese would not be readily understood without the tones. For example, the character “ma” can either mean “mother” or “horse” or a “question” depending the tone. In China many dialects are spoken. Spoken words are almost unintelligible from one dialect to the next. However, there is only one written Chinese. Written Chinese is understood by all dialects. Other Sino-Tibetan languages such as Japanese, Korean, and Vietnamese use several characters common to Chinese. However, these languages have no common written or spoken meaning, similar to the manner in which English, Spanish, and French use a common alphabet but are not otherwise interchangeable.

Following the Chinese Communist revolution in 1949, the Communist party made several changes to the Chinese language. First, the traditional method of writing Chinese from “top to bottom” and “right to left” was abandoned. The Peoples' Republic of China (PRC or mainland China) now follows Western languages and is written from “left to right” and then “top to bottom.” Second, a single dialect was chosen, Mandarin, which is now taught in all schools as the primary Chinese language. Third, the PRC altered about one quarter of the characters to reduce them to around seven lines or strokes. This form of Chinese is called “Simplified Chinese.” In the PRC, Simplified Chinese is now widely used, but the Republic of Chine (ROC or Taiwan) and Hong Kong still use the more elaborate form of Chinese called “Traditional Chinese.” The PRC also adopted the Hindu-Arabic numbering system used by most Western countries and the advent of the Internet is causing English to appear in many Chinese sentences.

The PRC also introduced “Pin Yin,” a phonetic version of Chinese to help young children learn the language. Pin Yin uses the 26 letters of the English alphabet plus 4 accents over certain vowels to indicate how the character should be pronounced. Pin Yin is normally used from about 4 years of age until around 7 years of age when the students are taught to use Chinese Characters. Pin Yin is also very helpful for tourists and businessmen to speak Chinese from phrase books. Additionally, Pin Yin is popular with computer users as it is the easiest way to enter Chinese characters from a keyboard.

In the computer, all Sino-Tibetan languages are represented by 16-bit characters, while English and the other Latin languages are normally represented by 8-bit characters. Traditionally, separate encodings were produced for each of the languages. English uses a 7 bit encoding called ASCII. ASCII encoding is included as the first seven bits of all the other encodings. European languages are normally 8 bit encodings and make use of the eighth bit for their special characters. Simplified Chinese uses GB2312 encoding and Traditional Chinese uses Big 5 encoding. A computer using Big 5 encoding cannot read computer code in GB23 12. This multiplicity, of encodings is confusing and there is no standardization between the different encodings. The Unicode consortium has developed a single encoding that incorporates all the major languages of the world. There is a strong movement to use Unicode and replace all the other encodings in computer applications. Unicode uses 16 bits for each character inside the computer. Unicode has 65,000 different characters and each of the major languages is mapped into a different section of this Unicode range. Consequently, Unicode can be used as a single encoding scheme for all of the world's languages.

Chinese characters are encoded entries which can be displayed in different font sizes. In other words, a computer may display the Chinese characters in different sizes similar to the method by which a computer displays English characters and words in different font sizes using ASCII. Changing the font size is very beneficial to students studying. Chinese because the students may see the Chinese characters in greater detail.

Individual characters, letters, or symbols can be represented using different schemes within Unicode. Two of the most popular encoding schemes are UTF-8 and UCS-2. UTF-8 is a byte based Unicode encoding scheme which represents each character, letter, or symbol as one, two, or three bytes, each byte being eight bits. In contrast, UCS-2 is 16 bit encoding scheme which represents each character, letter, or symbol as 16 bits or four hexadecimal digits. One hexadecimal digit is equivalent to 4 bits, and 1 byte can be expressed by two hexadecimal digits. Table 1 below displays the difference between UTF-8 and UCS-2.

TABLE 1

| UCS-2 | | |
|---|---|---|
| (Hexadecimal) | UTF-8 (Binary) | Description |
| 0000 007F | 0xxxxxxx | ASCII |
| 0080 07FF | 110xxxxx 10xxxxxx | Up to U + 07FF |
| 0800 FFFF | 1110xxxx 10xxxxxx 10xxxxxx | Other UCS-2 |

A user may choose to encode using the UCS-2 scheme or the UTF-8 scheme depending on the user's expected needs. For example, when transmitting data from one location to another, or when storing data in a database, UTF-8 is the preferred encoding scheme due to the transmission efficiency and the storage efficiency inherent in variable byte stream length (i.e. 1-3 bytes, as shown in Table 1). However, when holding the same information in a memory, UCS-2 is the encoding scheme. Conversion functions between UCS-2 and UTF-8 are available as evidenced by United States Patent Application Publication 2003/0078921 entitled “Table-Level Unicode Handling in a Database Engine,” incorporated herein by reference.

Prior to the development of Unicode, a computerized character translator between Simplified Chinese and Traditional Chinese within the same encoding was impossible because of the inability of GB2312 code to understand Big 5 code, and vice-versa. If the user desired a computer-implemented translation, multiple encodings had to be used which did not permit simultaneous display of both forms of data.

Similarly, the prior art translation programs have been unable to display Pin Yin with the proper accents. Typically, these programs would use pictures in the form of gifs or jpegs to represent the characters. The accented vowels indicate the proper tone and are essential to proper pronunciation of Pin Yin. One technique that uses only the ASCII characters is based on adding a number after the Pin Yin word to indicate the accent as illustrated in Table 2.

TABLE 2

| Number | Accent | Description | Examples |
|---|---|---|---|
| 1 | - | Level Tone | \overline{a} \overline{e} \overline{i} \overline{o} \overline{u} |
| 2 | \acute{+0} | Rising Tone | á é í ó ú |
| 3 | \check{} | Falling Tone, then Rising Tone | \check{a} \check{e} \check{i} \check{o} \check{u} |
| 4 | \grave{+0} | Falling Tone | à è ì ò ù |
| 5 | (None) | No Change in Tone | a e i o u |

Thus, the prior art would display the word guó as guo2, the word m\overline{a} as ma1, and so forth. The prior art hybrid version of Pin Yin is difficult for the beginning reader to understand because the reader must make a cognitive leap between the number and proper type and location of the accent. Therefore, a need exists for an automated method for translating between Simplified Chinese, Traditional Chinese, Pin Yin, and English. The need extends to a method for displaying the Pin Yin with the proper accent marks.

Moreover, the possibility exists that the user may want a series of words that are similar to a user input. A series of words is useful when the user is attempting to communicate a point with particularity, such as in business negotiations. In these types of situations, it would be useful for the user to designate whether the user input is the entire desired word, the beginning of the desired word, or merely present anywhere in the desired word. Therefore, a need exists for an automated method for translating between Simplified Chinese, Traditional Chinese, accented Pin Yin, and English which allows the user to designate the type of output desired.

### SUMMARY OF THE INVENTION

The present invention is a methodology for translating between a Simplified Chinese character, a Traditional Chinese character, a Pin Yin word, and an English word. The software embodiment of the present invention is a computer program operable on a web page or as a program on a stand-alone computer. The software embodiment of the present invention comprises a Dictionary Program (DP). The DP accepts a character or word in Big 5, GB2312, ASCII, or any Unicode encoding scheme and translates the character or word into Unicode. The DP then determines if the user input is the entire desired word, the beginning of the desired word, or appears anywhere in the desired word and runs either the Entire Word Translation Program (EWTP), the Beginning of the Word Translation Program (BWTP), or the Anywhere in the Word Translation Program (AWTP) as appropriate. The DP also determines the font size the user designated for displaying the Chinese characters. DP then displays the Traditional Chinese word, the Simplified Chinese word, the accented Pin Yin word, and the English word.

The EWTP, the BWTP, and the AWTP determine if the user input is a Traditional Chinese character, a Simplified Chinese character, a Pin Yin word, or an English Word. The EWTP, the BWTP, and the AWTP translate the user input, as required, into the Traditional Chinese character, the Simplified Chinese character, the accented Pin Yin word, and the English word. The EWTP, the BWTP, and the AWTP Muse a Simplified Chinese/Traditional Chinese Conversion Table to translate between Simplified Chinese characters and Traditional Chinese characters. The EWTP, the BWTP, and the AWTP also use a Traditional Chinese/Pin Yin/English Dictionary to translate between Traditional Chinese characters, Pin Yin, and English. If the entered character is a Traditional Chinese character and does not have a Simplified Chinese equivalent, then The EWTP, the BWTP, and the AWTP display a message indicating that the Traditional Chinese character does not have a Simplified Chinese equivalent.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of the memory used to implement the present invention;

FIG. 3 is an illustration of the logic of the Dictionary Program (DP) of the present invention;

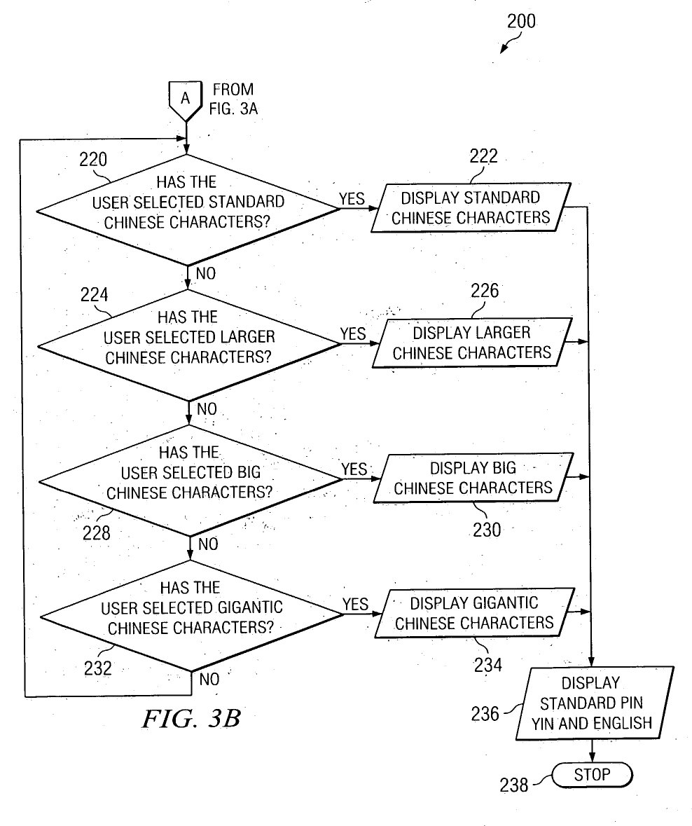

FIG. 4 is an illustration of the logic of the Entire Word Translation Program (EWTP) of the present invention;

FIG. 5 is an illustration of the logic of the Beginning of the Word Translation Program (BWTP) of the present invention;

FIG. 6 is an illustration of the logic of the Anywhere in the Word Translation Program (AWTP) of the present invention;

FIG. 7 is an illustration of the graphical user interface (GUI) of the present invention displaying the entire translation of the user input;

FIG. 8 is an illustration of the graphical user interface (GUI) of the present invention displaying the translations with the user input at the beginning of the word;

FIG. 9 is an illustration of the graphical user interface (GUI) of the present invention displaying the translations containing the user input anywhere in the word; and

FIG. 10 is an illustration of the graphical user interface (GUI) of the present invention displaying the variable font size of the Chinese characters of the present invention.

### DETAILED DESCRIPTION OF THE PREFERRED EMBODIMENT

As used herein, the term “accented Pin Yin” means the Pin Yin phonetic version of the Chinese language with proper accents over the appropriate Roman letters.

As used herein, the term “ASCII” is an acronym for American Standard Code for Information Interchange and means the encoding language for Roman letters, Arabic numbers, control characters, and the various symbols present on a QWERTY keyboard.

As used herein, the term “Big 5” means the encoding language for the Traditional Chinese character set.

As used herein, the term “computer” shall mean a machine having a processor, a memory, and an operating system, capable of interaction with a user or other computer, and shall include without limitation desktop computers, notebook computers, personal digital assistants (PDAs), servers, handheld computers, and similar devices.

As used herein, the term “GB2312” means the encoding language for the Simplified Chinese character set.

As used herein, the term “hybrid Pin Yin” means the Pin Yin phonetic version of the Chinese language without proper accents over the appropriate Roman letters, but instead with numbers in or at the end of the word to represent the accent marks.

As used herein, the term “unaccented Pin Yin” means the Pin Yin phonetic version of the Chinese language without proper accents over the appropriate Roman letters.

As used herein, the term “Unicode” means the encoding language developed by the Unicode consortium comprising most of the world's languages including the Simplified Chinese character set and the Traditional Chinese character set.

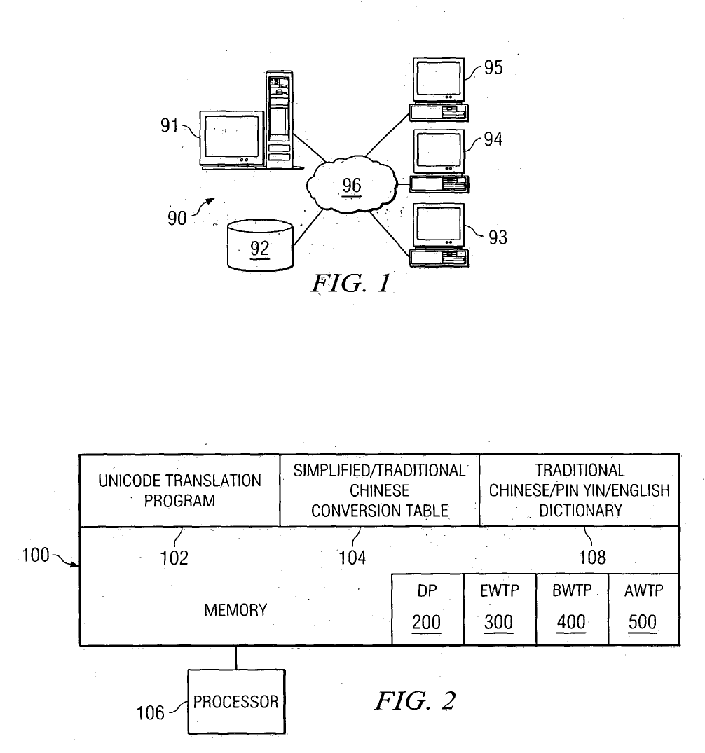

FIG. 1 is an illustration of computer network 90 associated with the present invention.

Computer network 90 comprises local machine 95 electrically coupled to network 96. Local machine 95 is electrically coupled to remote machine 94 and remote machine 93 via network 96.

Local machine 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of a possible operating network that may contain the present invention and is not meant as an architectural limitation.

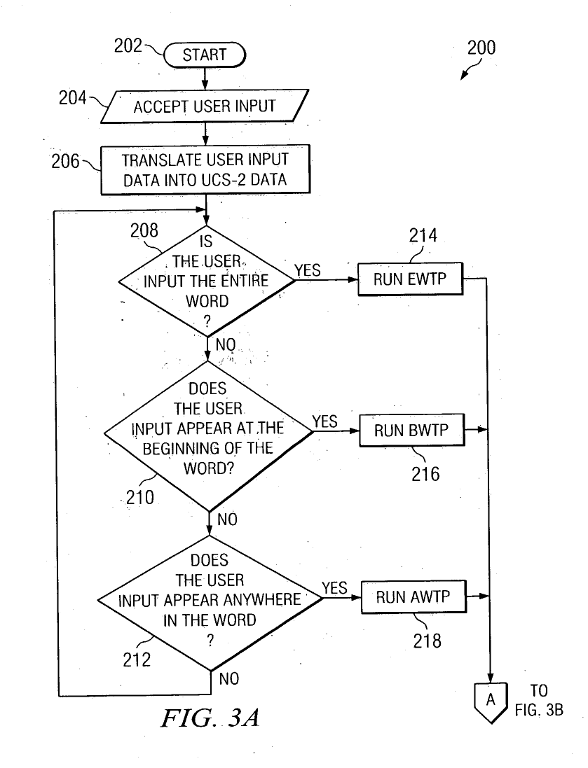

The internal configuration of a computer, including connection and orientation of the processor, memory, and input/output devices, is well known in the art. The present invention is a methodology that can be embodied in a computer program. Referring to FIG. 2, the methodology of the present invention is implemented on software by Dictionary Program (DP) 200, Entire Word Translator Program (EWTP) 300, Beginning of the Word Translator Program (BWTP) 400 and Anywhere in the Word Translator Program (AWTP) 500. DP 200, EWTP 300, BWTP 400, and AWTP 500 described herein can be stored within the memory of any computer depicted in FIG. 1. Alternatively, DP 200, EWTP 300, BWTP 400, and AWTP 500 can be stored in an external storage device such as a removable disk or a CD-ROM. Memory 100 is illustrative of the memory within one of the computers of FIG. 1. Memory 100 also contains Unicode Dictionary Program 102, Simplified Chinese/Traditional Chinese Conversion Table 104, and Traditional Chinese/Pin Yin/English Dictionary 108. The present invention may interface with Unicode Dictionary Program 102, Simplified Chinese/Traditional Chinese Conversion Table 104, and Traditional Chinese/Pin Yin/English Dictionary 108 through memory 100. As part of the present invention, the memory 100 can be configured with DP 200, EWTP 300, BWTP 400, and/or AWTP 500. Processor 106 can execute the instructions contained in DP 200, EWTP 300, BWTP 400, and/or AWTP 500.

In alternative embodiments, DP 200, EWTP 300, BWTP 400, and/or AWTP 500 can be stored in the memory of other computers. Storing DP 200, EWTP 300, BWTP 400, and/or AWTP 500 in the memory of other computers allows the processor workload to be distributed across a plurality of processors instead of a single processor. Further configurations of DP 200, EWTP 300, BWTP 400, and/or AWTP 500 across various memories are known by persons skilled in the art.

In the preferred embodiment, the present invention is a web page accessible from the Internet. DP 200 starts (202) when the user accesses the web page. The user then enters user input comprising a Chinese character, Pin Yin, or English word (204). The user input entered at step 204 may be a Traditional Chinese character, a Simplified Chinese character, an accented Pin Yin word, an unaccented Pin Yin word, a hybrid Pin Yin word, or an English word. Moreover, the input in step 204 may be in GB2312, Big 5, or any Unicode format. DP 200 accepts GB2312, Big 5, or Unicode encoding (i.e. UTF-8) because DP 200 translates the character data into UCS-2 data (206). DP 200 may utilize Unicode translation Program 102 in FIG. 2 to translate the entered character into UCS-2 data. Translation program between either hybrid Pin Yin or unaccented Pin Yin and either Traditional Chinese or Simplified Chinese are known to persons of ordinary skill in the art. Although GB2312 and Big 5 are incompatible with each other, both GB2312 and Big 5 are compatible with Unicode. In other words, a web page encoded in GB2312 will not recognize Big 5 characters and a web page encoded in Big 5 will not recognize GB2312 characters. However, a web page encoded in Unicode will recognize both GB2312 characters and Big 5 characters because Unicode contains both the GB2312 characters and the Big 5 characters.

DP 200 then makes a determination whether the user has indicated that the user input is the entire word (208). If the user has not indicated that the user input is the entire word, then DP 200 proceeds to step 210. If the user has indicated that the user input is the entire word, then DP 200 runs EWTP 300 (214) and proceeds to step 220. DP 200 then makes a determination whether the user has indicated that the user input is the beginning of the desired word (210). If the user has not indicated that the user input is the beginning of the desired word, then DP 200 proceeds to step 216. If the user has indicated that the user input is the beginning of the desired word, then DP 200 runs BWTP 400 (216) and proceeds to step 220. DP 200 then makes a determination whether the user has indicated that the user input may appear anywhere in the desired word (212). If the user has not indicated that the user input may appear anywhere in the desired word, then DP 200 proceeds to step 208. If the user has indicated that the user input may appear anywhere in the desired word, then DP 200 runs AWTP 500 (218) and proceeds to step 220.

As part of the present invention, the user may indicate the desired display size of the Simplified Chinese and the Traditional Chinese characters. Because the Chinese characters are encoded in Unicode, the font size of the characters may be easily changed. Previously, users have been able to change the font size of Simplified Chinese characters if the characters were encoded in GB2312, but could not display the Traditional Chinese characters. Similarly, users have been able to change the font size of Traditional Chinese characters if the characters were encoded in Big 5, but could not display the Simplified Chinese characters.

At step 220, DP 200 determines whether the user has selected standard size Chinese characters (220). Standard size characters are the default size characters and are typically twelve-point font size. Persons of ordinary skill may configure the standard size characters to any font size. If DP 200 determines that the user has not selected standard size Chinese characters, the DP 200 proceeds to step 224. If DP 200 determines that the user has selected standard size Chinese characters, DP 200 displays the Simplified Chinese characters and the Traditional Chinese characters in the standard font size (222). DP 200 then proceeds to step 236.

At step 224, DP 200 determines whether the user has selected larger size Chinese characters (224). Larger size characters are typically sixteen-point font size. Persons of ordinary skill may configure the larger size characters to any font size. If DP 200 determines that the user has not selected larger size Chinese characters, the DP 200 proceeds to step 228. If DP 200 determines that the user has selected larger size Chinese characters, DP 200 displays the Simplified Chinese characters and the Traditional Chinese characters in the larger font size (226). DP 200 then proceeds to step 236.

At step 220, DP 200 determines whether the user has selected big size Chinese characters (228). Big size characters are typically twenty-point font size. Persons of ordinary skill may configure the big size characters to any font size. If DP 200 determines that the user has not selected big size Chinese characters, the DP 200 proceeds to step 232. If DP 200 determines that the user has selected big size Chinese characters, DP 200 displays the Simplified Chinese characters and the Traditional Chinese characters in the big font size (230). DP 200 then proceeds to step 236.

At step 220, DP 200 determines whether the user has selected huge size Chinese characters (232). Huge size characters are typically twenty-four-point font size. Persons of ordinary skill may configure the huge size characters to any font size. If DP 200 determines that the user has not selected huge size Chinese characters, the DP 200 returns to step 220. If DP 200 determines that the user has selected huge size Chinese characters, DP 200 displays the Simplified Chinese characters and the Traditional Chinese characters in the huge font size (234). DP 200 then proceeds to step 236.

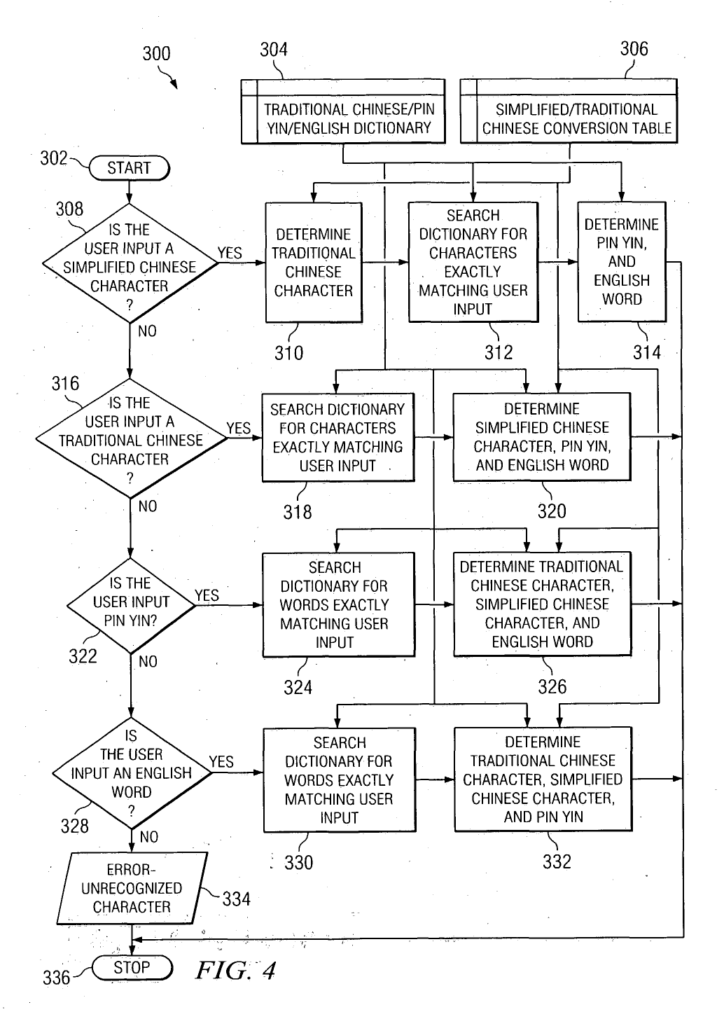

At step 236, DP 200 displays the accented Pin Yin word and the English word in the standard size (236). In an alternative embodiment, DP 200 enables the user to vary the font size of the Pin Yin word and the English word as well as the Chinese characters. DP 200 then ends (238). A flowchart of the logic of EWTP 300 of the present invention is illustrated in FIG. 4. EWTP 300 is a program which searches Traditional Chinese/Pin Yin/English dictionary 304 for entries exactly matching the user input. EWTP 300 also translates the user input into Simplified Chinese characters, Traditional, Chinese characters, a Pin Yin word, and an English word, as required. EWTP 300 starts (302) when directed by DP 200. EWTP 300 then makes a determination whether the user input is Simplified Chinese characters (308). If the user input is not Simplified Chinese characters, EWTP 300 proceeds to step 316. If the user input is Simplified Chinese characters, then EWTP 300 uses Simplified Chinese/Traditional Chinese Conversion Table 306 to determine the Traditional Chinese characters equivalent to the Simplified Chinese characters (310). Simplified Chinese/Traditional Chinese Conversion Table 306 is a JAVA™ hashtable, encoded in Unicode, which contains a cross-reference between all of the Simplified Chinese characters and their equivalent Traditional Chinese characters. Simplified Chinese/Traditional Chinese Conversion Table 306 may be like Simplified Chinese/Traditional Chinese Conversion Table 104 in FIG. 2. The data in the hashtable is in the UCS-2 Unicode format. Because there are about 1,250 Simplified Chinese characters, the hashtable contains approximately 2,500 entries—one for each Simplified Chinese character and the Traditional Chinese equivalent.

At step 312, EWTP 300 searches Traditional Chinese/Pin Yin/English dictionary 304 for an entry exactly matching the user input (312). EWTP 300 then uses Traditional Chinese/Pin Yin/English dictionary 304 to determine the accented Pin Yin and English translations of the Traditional Chinese characters (314). Traditional Chinese/Pin Yin/English dictionary 304 is a dictionary, encoded in Unicode, containing entries for all of the Traditional Chinese characters with the accented Pin Yin and English translations. Where there may be more than one meaning for a given user input, Traditional Chinese/Pin Yin/English dictionary 304 gives the most commonly used word for the user input. Alternatively, Traditional Chinese/Pin Yin/English dictionary 304 could give some or all of the meanings for the user input. Traditional Chinese/Pin Yin/English dictionary 304 may be like Traditional Chinese/Pin Yin/English dictionary 108 in FIG. 2. EWTP 300 then ends (336).

Returning to step 316, EWTP 300 then makes a determination whether the user input is a Traditional Chinese character (316). If the user input is not a Traditional Chinese character, EWTP 300 proceeds to step 322. If the user input is a Traditional Chinese character, then EWTP 300 searches Traditional Chinese/Pin Yin/English dictionary 304 for an entry exactly matching the user input (318). EWTP 300 then uses Traditional Chinese/Pin Yin/English dictionary 304 and Simplified Chinese/Traditional Chinese Conversion Table 306 to determine the Simplified Chinese characters, the accented Pin Yin word, and the English word translations of the Traditional Chinese character (320). EWTP 300 then ends (336). If the entered character is a Traditional Chinese character and does not have a Simplified Chinese equivalent, then EWTP 300 displays a message indicating that the Traditional Chinese character does not have a Simplified Chinese equivalent.

Returning to step 322, EWTP 300 then makes a determination whether the user input is a Pin Yin word (322). If the user input is not a Pin Yin word, EWTP 300 proceeds to step 328. If the user input is a Pin Yin word, then EWTP 300 searches Traditional Chinese/Pin Yin/English dictionary 304 for an entry exactly matching the user input (324). EWTP then uses Traditional Chinese/Pin Yin/English dictionary 304 and Simplified Chinese/Traditional Chinese Conversion Table 306 to determine the Simplified Chinese characters, the Traditional Chinese characters, and the English word translations of the Pin Yin word (326). EWTP 300 then ends (336).

Returning to step 328, EWTP 300 then makes a determination whether the user input is an English word (328). If the user input is not an English word, EWTP 300 proceeds to step 334. If the user input is an English word, then EWTP 300 searches Traditional Chinese/Pin Yin/English dictionary 304 for an entry exactly matching the user input (330). EWTP 300 then uses Traditional Chinese/Pin Yin/English dictionary 304 and Simplified Chinese/Traditional Chinese Conversion Table 306 to determine the Traditional Chinese characters, the Simplified Chinese characters, and the accented Pin Yin word translations of the English word (332). EWTP 300 then ends (336).

At step 334, EWTP 300 displays an error message that the entered character is not a recognized Simplified Chinese character, Traditional Chinese character, Pin Yin word, or English word (334) and ends (336).

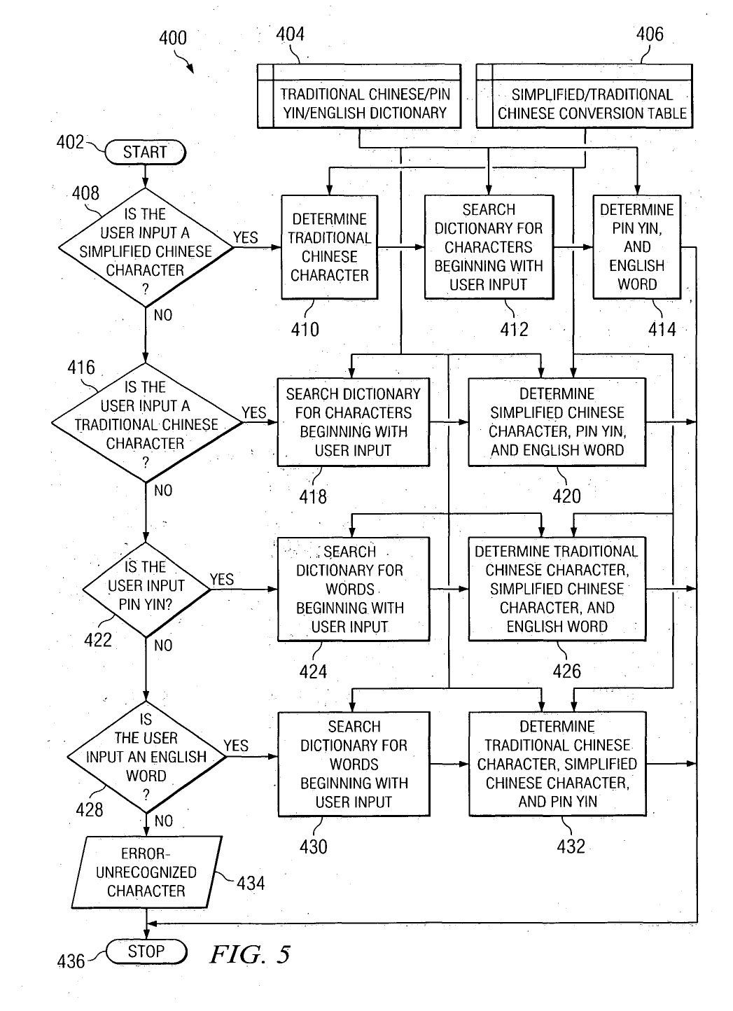

A flowchart of the logic of BWTP 400 of the present invention is illustrated in FIG. 5. BWTP 400 is a program which searches Traditional Chinese/Pin Yin/English dictionary 404 for entries beginning with the user input. BWTP 400 also translates the entries found in Traditional Chinese/Pin Yin/English dictionary 404 into Simplified Chinese characters, Traditional Chinese characters, a Pin Yin word, and an English word, as required. BWTP 400 starts (402) when directed by DP 200. BWTP 400 then makes a determination whether the user input is Simplified Chinese characters (408). If the user input is not Simplified Chinese characters, BWTP 400 proceeds to step 416. If the user input is Simplified Chinese characters, then BWTP 400 uses Simplified Chinese/Traditional Chinese Conversion Table 406 to determine the Traditional Chinese characters equivalent to the Simplified Chinese characters (410). Simplified Chinese/Traditional Chinese Conversion Table 406 may be like Simplified Chinese/Traditional Chinese Conversion Table 104 in FIG. 2.

At step 412, BWTP 400 searches Traditional Chinese Pin Yin/English dictionary 404 for entries beginning with the user input (412). BWTP 400 then uses Traditional Chinese/Pin Yin/English dictionary 404 to determine the accented Pin Yin and English translations of the Traditional Chinese characters (414). Traditional Chinese/Pin Yin/English dictionary 404 may be like Traditional Chinese/Pin Yin/English dictionary 108 in FIG. 2. BWTP 400 then ends (436).

Returning to step 416, BWTP 400 then makes a determination whether the user input is a Traditional Chinese character (416). If the user input is not a Traditional Chinese character, BWTP 400 proceeds to step 422. If the user input is a Traditional Chinese character, then BWTP 400 searches Traditional Chinese/Pin Yin/English dictionary 404 for entries beginning with the user input (418). BWTP 400 then uses Traditional Chinese/Pin Yin/English dictionary 404 and Simplified Chinese/Traditional Chinese Conversion Table 406 to determine the Simplified Chinese characters, the accented Pin Yin word, and the English word translations of the Traditional Chinese character (420). BWTP 400 then ends (436). If the entered character is a Traditional Chinese character and does not have a Simplified Chinese equivalent, then BWTP 400 displays a message indicating that the Traditional Chinese character does not have a Simplified Chinese equivalent.

Returning to step 422, BWTP 400 then makes a determination whether the user input is a Pin Yin word (422). If the user input is not a Pin Yin word, BWTP 400 proceeds to step 428. If the user input is a Pin Yin word, then BWTP 400 searches Traditional Chinese Pin Yin/English dictionary 404 for entries beginning with the user input (424). BWTP then uses Traditional Chinese/Pin Yin/English dictionary 404 and Simplified Chinese/Traditional Chinese Conversion Table 406 to determine the Simplified Chinese characters, the Traditional Chinese characters, and the English word translations of the Pin Yin word (426). BWTP 400 then ends (436).

Returning to step 428, BWTP 400 then makes a determination whether the user input is an English word (428). If the user input is not an English word, BWTP 400 proceeds to step 434. If the user input is an English word, then BWTP 400 searches Traditional Chinese/Pin Yin /English dictionary 404 for entries beginning with the user input (340). BWTP 400 then uses Traditional Chinese/Pin Yin/English dictionary 404 and Simplified Chinese/Traditional Chinese Conversion Table 406 to determine the Traditional Chinese characters, the Simplified Chinese characters, and the accented Pin Yin word translations of the English word (342). BWTP 400 then ends (436).

At step 434, BWTP 400 displays an error message that the entered character is not a recognized Simplified Chinese character, Traditional Chinese character, Pin Yin word, or English word (434) and ends (436).

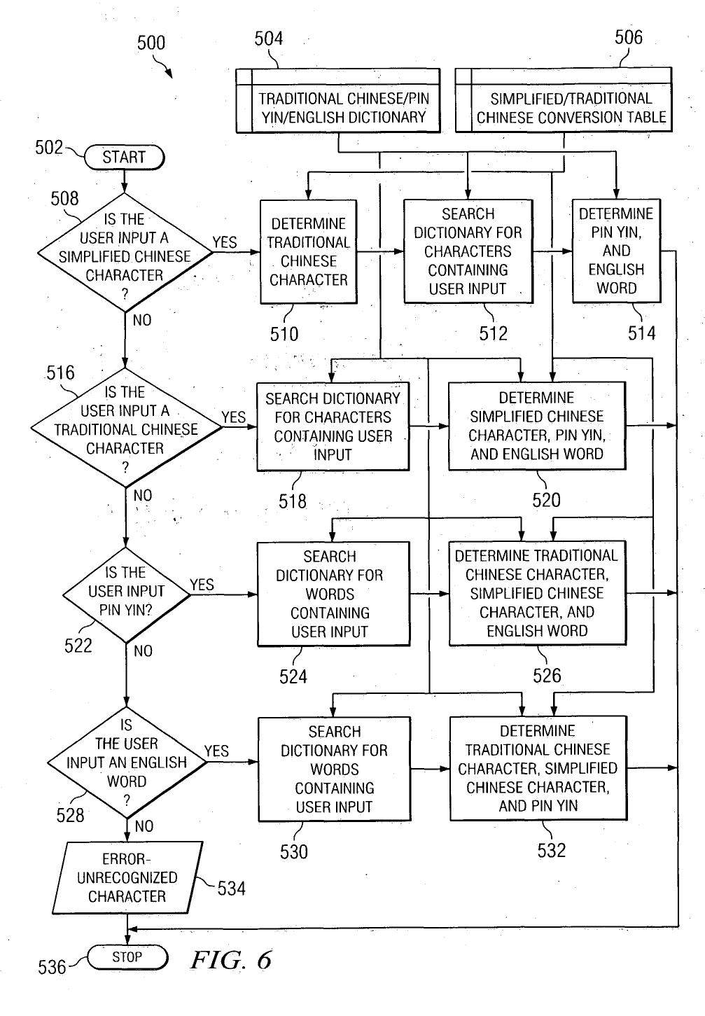

A flowchart of the logic of AWTP 500 of the present invention is illustrated in FIG. 6. AWTP 500 is a program which searches Traditional Chinese/Pin Yin/English dictionary 504 for entries containing the user input. AWTP 500 also translates the entries found in Traditional Chinese/Pin Yin/English dictionary 504 into Simplified Chinese characters, Traditional Chinese characters, a Pin Yin word, and an English word, as required. AWTP 500 starts (502) when directed by DP 200. AWTP 500 then makes a determination whether the user input is Simplified Chinese characters (508). If the user input is not Simplified Chinese characters, AWTP 500 proceeds to step 516. If the user input is Simplified Chinese characters, then AWTP 500 uses Simplified Chinese/Traditional Chinese Conversion Table 506 to determine the Traditional Chinese characters equivalent to the Simplified Chinese characters (510). Simplified Chinese/Traditional Chinese Conversion Table 506 may be like Simplified Chinese/Traditional Chinese Conversion Table 104 in FIG. 2.

At step 512, AWTP 500 searches Traditional Chinese/Pin Yin/English dictionary 504 for entries containing the user input (512). The entries may contain the user input anywhere in the word. AWTP 500 then uses Traditional Chinese/Pin Yin/English dictionary 504 to determine the accented Pin Yin and English translations of the Traditional Chinese characters (514). Traditional Chinese/Pin Yin/English dictionary 504 may be like Traditional Chinese/Pin Yin/English dictionary 108 in FIG. 2. AWTP 500 then ends (536).

Returning to step 516, AWTP 500 then makes a determination whether the user input is a Traditional Chinese character (516). If the user input is not a Traditional Chinese character, AWTP 500 proceeds to step 522. If the user input is a Traditional Chinese character, then AWTP 500 searches Traditional Chinese/Pin Yin/English dictionary 504 for entries containing the user input (518). AWTP 500 then uses Traditional Chinese/Pin Yin/English dictionary 504 and Simplified Chinese/Traditional Chinese Conversion Table 506 to determine the Simplified Chinese characters, the accented Pin Yin word, and the English word translations of the Traditional Chinese character (520). AWTP 500 then ends (536). If the entered character is a Traditional Chinese character and does not have a Simplified Chinese equivalent, then AWTP 500 displays a message indicating that the Traditional Chinese character does not have a Simplified Chinese equivalent.

Returning to step 522, AWTP 500 then makes a determination whether the user input is a Pin Yin word (522). If the user input is not a Pin Yin word, AWTP 500 proceeds to step 528. If the user input is a Pin Yin word, then AWTP 500 searches Traditional Chinese/Pin Yin/English dictionary 504 for entries containing the user input (524). AWTP then uses Traditional Chinese Pin Yin/English dictionary 504 and Simplified Chinese/Traditional Chinese Conversion Table 506 to determine the Simplified Chinese characters, the Traditional Chinese characters, and the English word translations of the Pin Yin word (526). AWTP 500 then ends (536).

Returning to step 528, AWTP 500 then makes a determination whether the user input is an English word (528). If the user input is not an English word, AWTP 500 proceeds to step 534. If the user input is an English word, then AWTP 500 searches Traditional Chinese/Pin Yin/English dictionary 504 for entries containing the user input (350). AWTP 500 then uses Traditional Chinese/Pin Yin/English dictionary 504 and Simplified Chinese/Traditional Chinese Conversion Table 506 to determine the Traditional Chinese characters, the Simplified Chinese characters, and the accented Pin Yin word translations of the English word (352). AWTP 500 then ends (536).

At step 534, AWTP 500 displays an error message that the entered character is not a recognized Simplified Chinese character, Traditional Chinese character, Pin Yin word, or English word (534) and ends (536).

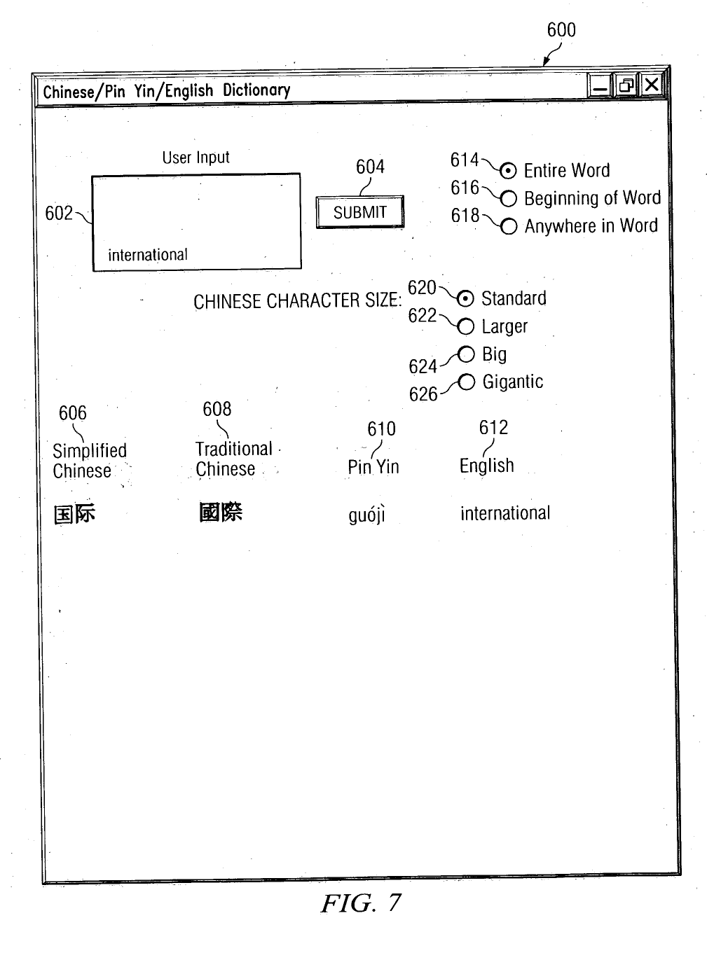

Turning to FIG. 7, an embodiment of Graphical User Interface (GUI) 600 of the present invention is illustrated. GUI 600 is an example of the contents of the web page embodiment of the present invention. GUI 600 is also an example of the display of the stand-alone computer program embodiment of the present invention which is operable on a single computer. GUI 600 contains a user input field 602. The user may input a character into user input field 602 utilizing the copy-and-paste operation of a computer. In a copy-and-paste operation, the user highlights the desired character, chooses “copy” from a menu, places the cursor in user input field 602, and selects “paste” from a menu. The highlighted character then appears in user input field 602. Persons of ordinary skill in the art are aware of methods for implementing copy-and-paste operations on a computer. The user may also input the character into user input field 602 by any method known by persons of ordinary skill in the art.

As part of the present invention, when the user utilizes the copy-and-paste operation to input a character into user input field 602, DP 200 will recognize the entered character regardless of the encoding format used in the highlighted “copy” text. For example, a user may be viewing another web page written in Traditional Chinese and come across a character the user does not recognize. The user may then highlight the unrecognized character, copy the character, paste the character in user input field 602, and click submit button 604 to determine the Simplified Chinese character equivalent for the Traditional Chinese character. The present invention accepts the Big 5 encoding used in the other web page because Big 5 is compatible with Unicode. In another example, a user may be viewing another web page written in Simplified Chinese and come across a character the user does not recognize. The user may then highlight the unrecognized character, copy the character, paste the character in user input field 602, and click submit button 604 to determine the Traditional Chinese character equivalent for the Simplified Chinese character. The present invention accepts the GB2312 encoding used in the other web page because GB2312 is compatible with Unicode. If the present invention was implemented in either Big 5 or GB2312 encoding, the present invention would be limited to either Simplified Chinese or Traditional Chinese, depending on the encoding language. The user may also use the copy and paste function to input English words, accented Pin Yin, hybrid Pin Yin, or unaccented Pin Yin in the ASCII or Unicode formats.

After the user has inserted a character or word into user input field 602, the user may click submit button 604. Submit button 604 instructs DP 200 to analyze the character in the user input field 602. As seen in FIG. 7, the user has input the English word “international.” The user has also selected the entire word radio button 614 to indicate that user input is the entire word the user desires. The user could have also chose the beginning of word radio button 616 to indicate that the user input appears at the beginning of the desired word. Alternatively, the user can select the anywhere in word radio button 618 to indicate that the user input can appear anywhere in the word. The user has also selected the standard size radio button 620 to indicate the font size the user wants the Chinese characters displayed in. Alternatively, the user could have selected the larger radio button 622, the big radio button 624, or the gigantic radio button 626.

When the user clicks submit button 604, DP 200 displays the Simplified Chinese characters 606, the Traditional Chinese characters 608, the properly accented Pin Yin word 610, and the English translation 612 below user input field 602. In FIG. 7, the Chinese characters are displayed in the standard font size because the user selected standard radio button 620. Additionally, the DP 200 only displays the translation for the word international because the user selected the entire word radio button 614. The user may input as many words as desired and continue to utilize the present invention at will.

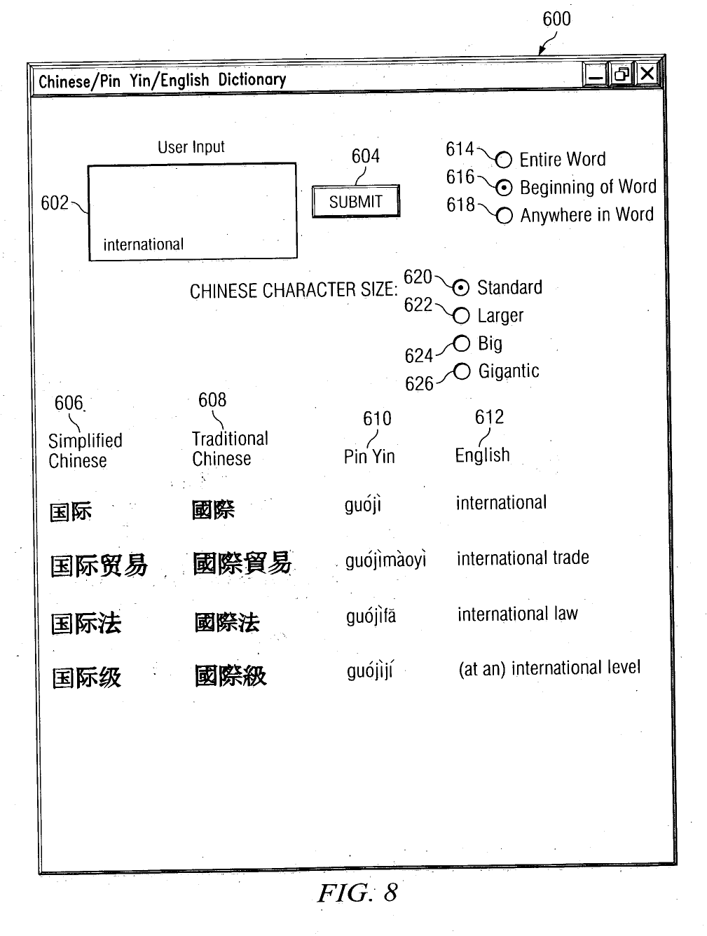

Turning to FIG. 8, GUI 600 is depicted again. In FIG. 8, the user has selected beginning of word radio button 616, indicating that the desired word begins with the user input “international.” As seen in FIG. 8, DP 200 produces the translations beginning with international.

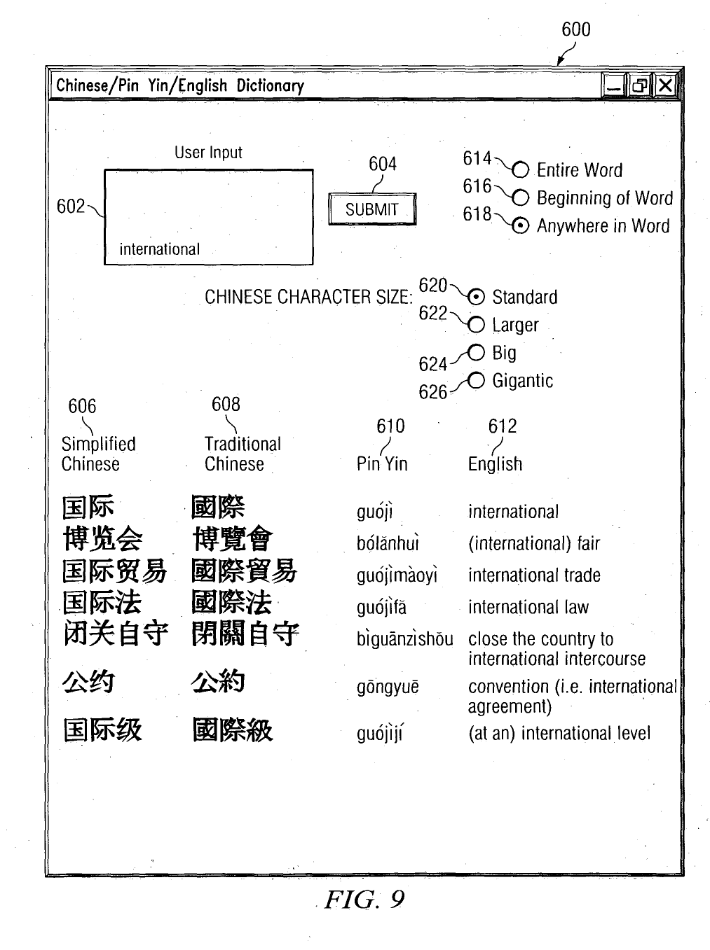

Turning to FIG. 9, GUI 600 is depicted again. In FIG. 9, the user has selected anywhere in word radio button 618, indicating that the desired word contains the user input “international” anywhere in the word. As seen in FIG. 8, DP 200 produces the translations containing international.

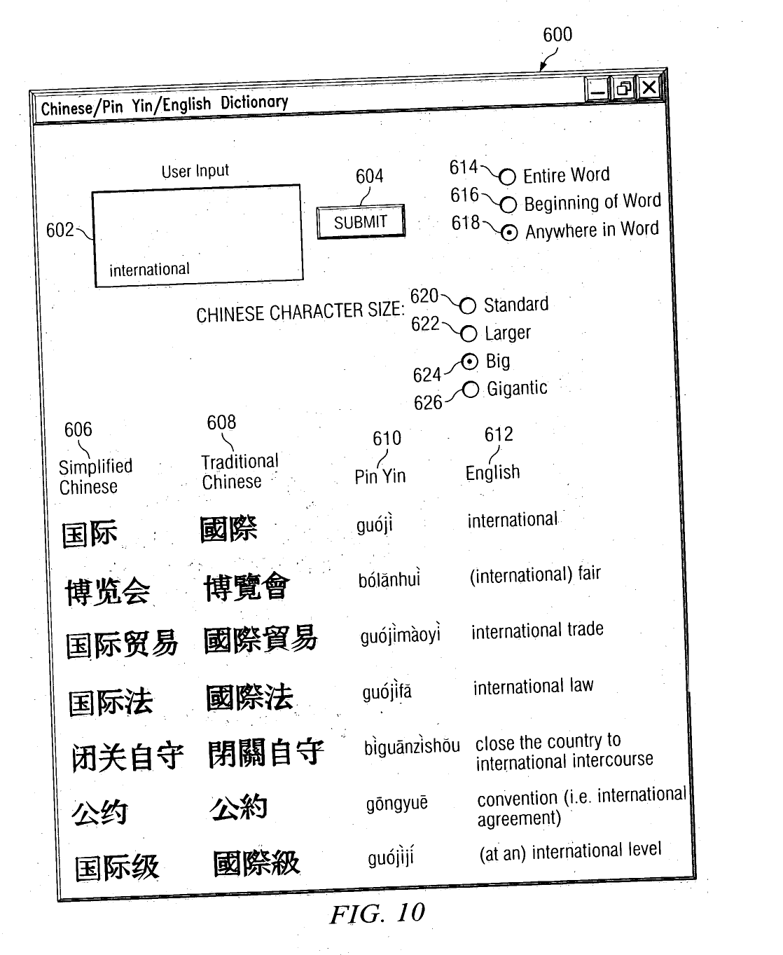

Turning to FIG. 10, GUI 600 is depicted again. In FIG. 10, the user has selected big radio button 624, indicating that the user wants the Chinese characters to be displayed in the big font size. The increased font size is particularly useful to students learning Chinese so that they may learn the distinctions between the Chinese characters.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The novel spirit of the present invention is still embodied by reordering or deleting some of the steps contained in this disclosure. The spirit of the invention is not meant to be limited in any way except by proper construction of the following claims.

1. A method comprising:
searching a dictionary for an entry containing a Simplified Chinese word;
using Unicode to determine a Traditional Chinese word equivalent of a Simplified Chinese word; and
using Unicode to translate the Simplified Chinese word into accented Pin Yin word and an English word.

2. The method of claim 1 wherein the entry exactly matches the Simplified Chinese word.

3. The method of claim 1 wherein the entry begins with the Simplified Chinese word.

4. The method of claim 1 wherein the entry contains the Simplified Chinese word anywhere in the entry.

5. The method of claim 1 further comprising: accepting the Simplified Chinese word as user input, wherein the Simplified Chinese word is encoded in GB2312 or Unicode.

6. The method of claim 1 further comprising: translating the Simplified Chinese word from GB2312 to Unicode.

7. The method of claim 1 further comprising:
displaying the Simplified Chinese word, the Traditional Chinese word, the accented Pin Yin word, and the English word; and
wherein the font size of the Simplified Chinese word and the font size of the Traditional Chinese word is user configurable.

8. A method comprising:
searching a dictionary for an entry containing a Traditional Chinese word;
using Unicode to determine a Simplified Chinese word equivalent of a Traditional Chinese word; and
using Unicode to translate the Traditional Chinese word into accented Pin Yin word and an English word.

9. The method of claim 8 wherein the entry exactly matches the Traditional Chinese word.

10. The method of claim 8 wherein the entry begins with the Traditional Chinese word.

11. The method of claim 8 wherein the entry contains the Traditional Chinese word anywhere in the entry.

12. The method of claim 8 further comprising: accepting the Traditional Chinese word as user input, wherein the Traditional Chinese word is encoded in Big 5 or Unicode.

13. The method of claim 8 further comprising: translating the Traditional Chinese word from Big 5 to Unicode.

14. The method of claim 8 further comprising:
displaying the Simplified Chinese word, the Traditional Chinese word, the accented Pin Yin word, and the English word; and
wherein the font size of the Simplified Chinese word and the font size of the Traditional Chinese word is user configurable.

15. A method comprising:
searching a dictionary for an entry containing a Pin Yin word; and
using Unicode to translate a Pin Yin word into a Traditional Chinese word, a Simplified Chinese word, and an English word.

16. The method of claim 15 wherein the entry exactly matches the Pin Yin word.

17. The method of claim 15 wherein the entry begins with the Pin Yin word.

18. The method of claim 15 wherein the entry contains the Pin Yin word anywhere in the entry.

19. The method of claim 15 wherein the Pin Yin word is an unaccented Pin Yin word or a hybrid Pin Yin word.

20. The method of claim 15 further comprising:
displaying the Simplified Chinese word, the Traditional Chinese word, the accented Pin Yin word, and the English word; and
wherein the font size of the Simplified Chinese word and the font size of the Traditional Chinese word is user configurable.

21. A method comprising:
searching a dictionary for an entry containing an English word; and
using Unicode to translate an English word into a Traditional Chinese word, a Simplified Chinese word, and an accented Pin Yin word.

22. The method of claim 21 wherein the entry exactly matches the English word.

23. The method of claim 21 wherein the entry begins with the English word.

24. The method of claim 21 wherein the entry contains the English word anywhere in the entry.

25. The method of claim 21 further comprising:
displaying the Simplified Chinese word, the Traditional Chinese word, the accented Pin Yin word, and the English word; and
wherein the font size of the Simplified Chinese word and the font size of the Traditional Chinese word is user configurable.

26. A program product operable on a computer, the program product comprising:
a computer-usable medium;
wherein the computer usable medium comprises instructions comprising:
instructions for searching a dictionary for an entry containing a Simplified Chinese word;
instructions for using Unicode to determine a Traditional Chinese word equivalent of a Simplified Chinese word; and
instructions for using Unicode to translate the Simplified Chinese word into accented Pin Yin word and an English word.

27. The program product of claim 26 wherein the entry exactly matches the Traditional Chinese word.

28. The program product of claim 26 wherein the entry begins with the Traditional Chinese word.

29. The program product of claim 26 wherein the entry contains the Traditional Chinese word anywhere in the entry.

30. The program product of claim 26 further comprising: instructions for accepting the Traditional Chinese word as user input, wherein the Traditional Chinese word is encoded in Big 5 or Unicode.

31. The program product of claim 26 further comprising: instructions for translating the Traditional Chinese word from Big 5 to Unicode.

32. The program product of claim 26 further comprising:
instructions for displaying the Simplified Chinese word, the Traditional Chinese word, the accented Pin Yin word, and the English word; and
wherein the font size of the Simplified Chinese word and the font size of the Traditional Chinese word is user configurable.

33. A program product operable on a computer, the program product comprising:
a computer-usable medium;
wherein the computer usable medium comprises instructions comprising:
instructions for searching a dictionary for an entry containing a Traditional Chinese word;
instructions for using Unicode to determine a Simplified Chinese word equivalent of a Traditional Chinese word; and
instructions for using Unicode to translate the Traditional Chinese word into accented Pin Yin word and an English word.

34. The program product of claim 33 wherein the entry exactly matches the Traditional Chinese word.

35. The program product of claim 33 wherein the entry begins with the Traditional Chinese word.

36. The program product of claim 33 wherein the entry contains the Traditional Chinese word anywhere in the entry.

37. The program product of claim 33 further comprising: instructions for accepting the Traditional Chinese word as user input, wherein the Traditional Chinese word is encoded in Big 5 or Unicode.

38. The program product of claim 33 further comprising: instructions for translating the Traditional Chinese word from Big 5 to Unicode.

39. The program product of claim 33 further comprising:
instructions for displaying the Simplified Chinese word, the Traditional Chinese word, the accented Pin Yin word, and the English word; and
wherein the font size of the Simplified Chinese word and the font size of the Traditional Chinese word is user configurable.

40. A program product operable on a computer, the program product comprising:
a computer-usable medium;
wherein the computer usable medium comprises instructions comprising:
instructions for searching a dictionary for an entry containing a Pin Yin word; and
instructions for using Unicode to translate a Pin Yin word into a Traditional Chinese word, a Simplified Chinese word, and an English word.

41. The program product of claim 40 wherein the entry exactly matches the Pin Yin word.

42. The program product of claim 40 wherein the entry begins with the Pin Yin word.

43. The program product of claim 40 wherein the entry contains the Pin Yin word anywhere in the entry.

44. The program product of claim 40 wherein the Pin Yin word is an unaccented Pin Yin word or a hybrid Pin Yin word.

45. The program product of claim 40 further comprising:
instructions for displaying the Simplified Chinese word, the Traditional Chinese word, the accented Pin Yin word, and the, English word; and
wherein the font size of the Simplified Chinese word and the font size of the Traditional Chinese word is user configurable.

46. A program product operable on a computer, the program product comprising:
a computer-usable medium;
wherein the computer usable medium comprises instructions comprising:
instructions for searching a dictionary for an entry containing an English word; and
instructions for using Unicode to translate an English word into a Traditional Chinese word, a Simplified Chinese word, and an accented Pin Yin word.

47. The program product of claim 46 wherein the entry exactly matches the English word.

48. The program product of claim 46 wherein the entry begins with the English word.

49. The program product of claim 46 wherein the entry contains the English word anywhere in the entry.

50. The program product of claim 46 further comprising:
displaying the Simplified Chinese word, the Traditional Chinese word, the accented Pin Yin word, and the English word; and
wherein the font size of the Simplified Chinese word and the font size of the Traditional Chinese word is user configurable.
